(19) United States
(12) Patent Application Publication
(10) Pub. No.: US 2003/0047653 A1
(43) Pub. Date: Mar. 13, 2003

(54) Multi-purpose bracket and method for retaining an electronics sub-assembly within a wood cabinet

(75) Inventor: Rodney Ballard, Knoxville, TN (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/948,399

(22) Filed: Sep. 7, 2001

(51) Int. Cl. F16M 11/00; G12B 9/00

(52) U.S. Cl. 248/200; 248/27.1

(57) ABSTRACT

A multi-purpose bracket for structurally joining the panels of a wood cabinet and for retaining a mounting frame to which electronic components are mounted as a sub-assembly within the cabinet. The bracket is made of an elongate piece of bent sheet metal, having a lower leg that mounts using screws to a bottom panel of the cabinet, a right angle connecting leg which includes a plurality of tabs that mount to an upright panel using screws, and a plurality of right angle retaining tabs which extend from the connecting leg to form a C-shaped cross-section thereat. Opposite peripheral edges of the appropriately dimensioned mounting frame slide into opposing multi-purpose brackets to simultaneously provide structural support for the cabinet and to retain the electronics sub-assembly frame within the cabinet.

### FIELD OF INVENTION

The present invention is directed generally towards brackets for assembling together wood cabinets, and more particularly towards a bracket for use with the wood cabinets of electronic devices wherein the bracket also retains an electronics component sub-assembly contained within the cabinet.

### BACKGROUND OF THE INVENTION

Wood is still widely used today for furniture due to its relatively low cost, ease of fabrication, and most importantly for the desirable look it imparts to furniture. The individual component parts of furniture are typically assembled together using adhesives, dowels, wood gussets, wood cleats, metal angle brackets, metal straps, and standard hardware such as screws, bolts, nuts, washers, rivets, nails, and staples.

The outer cabinets of many electronic appliances such as big screen televisions and audio systems are now also constructed of wood for similar reasons. Such electronic appliances have internal electronic components that must be secured within the wood cabinet. Often such electronic components are mounted on frames to form electronics chassis sub-assemblies that can be separately manufactured, then mounted within the wood cabinet at final assembly. This construction utilizing the wood cabinet and electronics chassis sub-assembly simplifies the manufacturing process while thermally and electrically insulating the user from the electronic components.

One example of a wood cabinet containing electronic components utilizes a construction wherein a plurality of wood cleats are connected to respective wood side and bottom members or panels at a lower portion of the cabinet. The wood cleats structurally connect together the individual panels and support the lower portion of the cabinet. An electronics chassis sub-assembly utilizing a plastic sub-assembly mounting frame is fastened to the bottom of the cabinet using a plurality of screws additional to those used to fasten the wood cleats. The area available for the electronics (e.g. the BCB board area) is less using this construction since the electronics chassis sub-assembly typically must fit between the wood cleats in order to mount to the bottom panel, and due to the space taken up by the screws for mounting the electronics chassis sub-assembly to cabinet. This makes the base area of the cabinet larger than necessary or conversely reduces the amount of electronic components that can be housed there.

### SUMMARY

In accordance with the present invention there is provided a multipurpose bracket and method for retaining a mounting frame of an electronics chassis sub-assembly within an electronics cabinet, and for mechanically joining together a bottom panel, and one of a pair of opposing upright panels of the cabinet. The bracket includes a lower leg adapted for mounting to the bottom panel, and a connecting leg angularly dependent from an edge of the lower leg. The connecting leg is adapted for mounting to one of the opposing upright panels. An upper leg is dependent from an opposite edge of the connecting leg in spaced orientation to the lower leg. A pair of the brackets is mountable in a spaced parallel relationship within the cabinet to the bottom panel and to the respective opposing upright panels to simultaneously provide structural support for the cabinet and to retain the electronics sub-assembly frame opposite portions of an outer edge thereof which are slidable therebetween.

The method for retaining a mounting frame of an electronics sub-assembly within an electronics cabinet, and for mechanically joining together a bottom panel, and a pair of opposing upright panels of the cabinet, comprises the steps of: 1) providing a pair of multi-purpose brackets adapted for mounting to the bottom panel and to one of the opposing upright panels, the brackets also being adapted to connect to the mounting frame, and 2) mounting the pair of the brackets in an opposing, spaced parallel relationship within the cabinet to the bottom panel and to the respective opposing upright panels to simultaneously provide structural support for the cabinet and provide the ability to retain the mounting frame within the cabinet.

### BRIEF DESCRIPTION OF THE DRAWINGS

A more complete understanding of the present invention may be obtained from consideration of the following description in conjunction with the drawings in which:

FIG. 1 shows a rear perspective view of an exemplary wood cabinet for a big screen television, the cabinet that uses a prior art construction of a plurality of wood cleats.

FIG. 2 shows a front perspective view of an exemplary embodiment of a multi-purpose bracket according to this invention.

FIG. 3 shows a rear perspective view of the exemplary cabinet corresponding to FIG. 2, but utilizing the multi-purpose bracket.

### DETAILED DESCRIPTION OF THE INVENTION

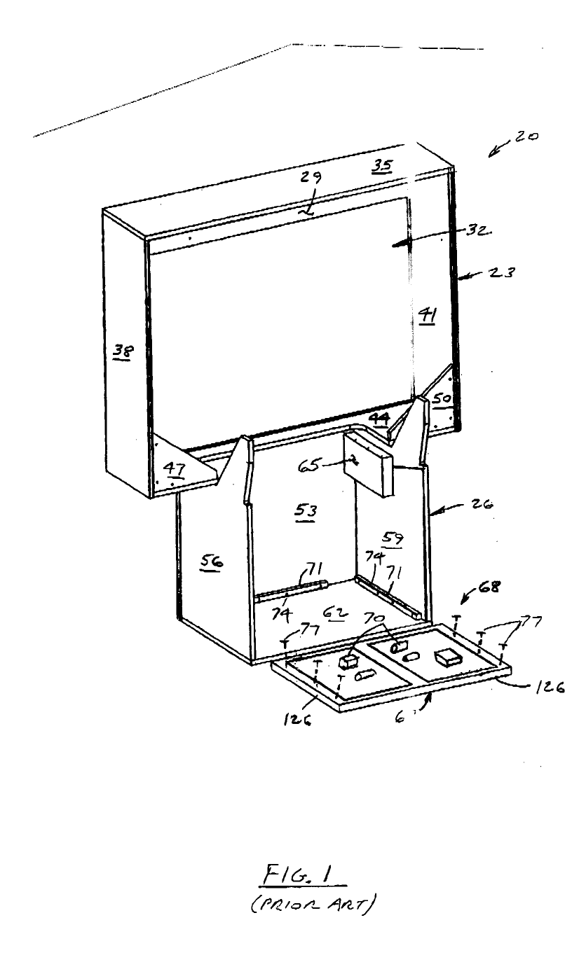

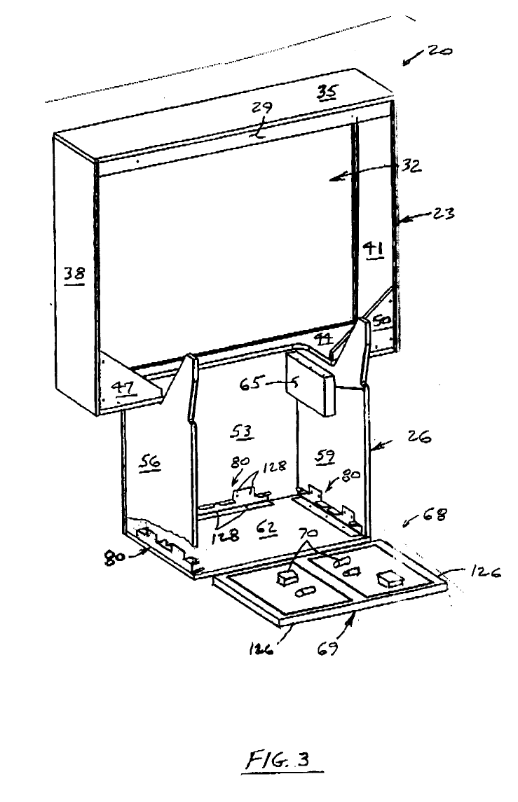

Referring to FIGS. 1 and 3 there is shown an exemplary wood cabinet for containing electronic components, comprising a wood television cabinet 20 which includes an upper display frame 23 and a lower support frame 26. The upper display frame 23 and the lower support frame 26 are each comprised of a plurality of members or panels that are typically made of wood, or similar materials available in panels for fabrication as needed. The panels are screwed together and can be glued for added strength. The upper display frame 23 includes an upper front panel 29 having a picture screen-receiving hole 32 therethrough, which is framed by a top panel 35, respective side panels 38 and 41, and a bottom panel 44. A pair of gussets 47 and 50 are attached to the respective side panels 38 and 41, and to the bottom panel 44 serve to square up and stiffen the upper display frame 23. The lower support frame 26 includes a transverse lower panel comprising a lower front panel 53 which is framed by the bottom panel 44, a pair of side panels 56 and 59, and a bottom panel 62. A wood mounting plate 65 is mounted to the side panel 59. An electronics chassis sub-assembly 68 comprises a mounting tray or frame 69 to which are mounted a variety of electronic components 70 to power and operate a television picture tube assembly (not shown) which fits within the picture screen-receiving hole 32. The electronics chassis sub-assembly 68 can mount to the lower support frame 26 in different ways as explained below.

As shown in FIG. 1, the prior art utilizes a plurality of wood cleats 71 and a plurality of screws 74 to mount the electronics chassis sub-assembly 68 to the cabinet 20. The screws 74 extend through the respective wood cleats 71 into the bottom panel 62, and into the respective lower front panel 53 and side panels 56 and 59 to fasten together the respective bottom panel 62, lower front panel 53, and side panels 56 and 59. The mounting frame 69 of the electronics chassis sub-assembly 68 fits above or between the respective wood cleats 71, and is affixed directly to the bottom panel 62 or to the cleats 71 using a plurality of screws 77 which extend through respective holes (not shown) in the mounting frame 69.

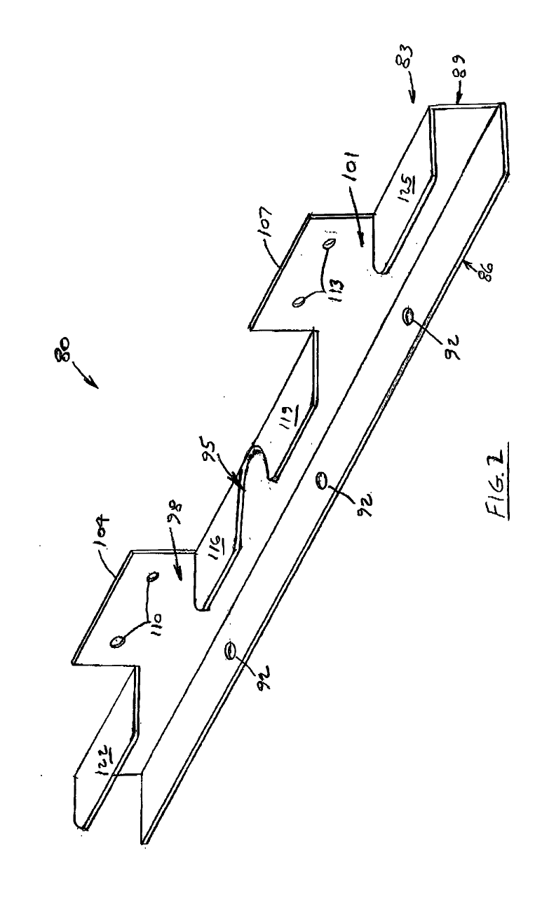

Conversely as shown in FIGS. 2 and 3, an exemplary multi-purpose bracket 80 according to the invention can replace the wood cleats 71 and the screws 74 and 77. The bracket 80 is of a C-shaped and L-shaped cross-section along its length, having respective horizontally disposed upper and lower legs 83 and 86 that are interconnected by a vertically disposed connecting leg 89. The lower leg 86 includes a plurality of clearance holes 92. The upper leg 83 is longitudinally discontinuous, having a central opening 95 disposed vertically adjacent one of the clearance holes 92, and a pair of recesses 98 and 101 formed where the connecting leg 89 is upwardly extended past the upper leg 83 to form respective mounting tabs 104 and 107. Pairs of clearance holes 110 and 113 extend through the respective tabs 104 and 107. The upper leg 83 therefore comprises a pair of horizontally disposed center retaining tabs 116 and 119, and end retaining tabs 122 and 125.

The brackets 80 are utilized by mounting each of at least a pair of brackets 80 in an opposing manner to the bottom panel 62, and to the lower front panel 53 or a respective side panel 56 and 59. A third bracket 80 can also be used as shown in FIG. 3. The central opening 95, and the tabs 104 and 107 provide for easier access to the respective screws 128 during assembly of the brackets 80 to the cabinet 20. The respective panels 62 and 53, 56, and 59 are secured together using a plurality of screws 128 which extend through the respective clearance holes 92, 110, and 113 of the brackets 80. It is readily apparent that the bracket 80 eliminates the need for the prior art wood cleats 71 and the plurality of screws 74 and 77, thus easing the assembly process. Opposite portions of a peripheral or outer edge 126 of the mounting frame 69 are then slip-fit between the pair of brackets 80 so as to be vertically retained between the respective upper and lower legs 83 and 86. Another portion of the outer edge of the mounting frame 69 engage the third mounting bracket 80 as the mounting frame slides further into the cabinet 20. The sliding can be reversed to remove the mounting frame 69 from the cabinet 20. The mounting frame 69 can be retained from sliding in a reverse manner by a rear panel (not shown) which screws to the side panels 56 and 59, and to the bottom panel 62, or by other conventional devices.

The advantages of the multi-purpose bracket and method of use of present invention over the prior art include: 1) the multi-purpose bracket provides both structural support for the panels of the wood cabinet and simultaneous support for the electronic components on the electronics chassis sub-assembly (i.e. dual purpose); 2) the multi-purpose bracket provides greater ease of manufacturability due to the use of less screws and the associated labor of installation in the tight interior of the cabinet; 3) the multi-purpose bracket provides more solid structural mounting for the electronics package at multiple places around the outer periphery of the electronics; and 4) the multi-purpose bracket provides more available space for mounting the electronic components or providing a smaller base for the cabinet.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications, which come within the scope of the appended claims is reserved.

What is claimed is:

1. A multi-purpose bracket for retaining an electronics chassis sub-assembly in an electronics cabinet, comprising:
a lower leg adapted for mounting to a bottom panel of the cabinet;
a connecting leg angularly dependent from an edge of said lower leg, said connecting leg being adapted for mounting to one of a pair of opposing upright panels of the cabinet; and
an upper leg, wherein a pair of brackets is mountable in a spaced parallel relationship within the cabinet to the bottom panel and to the respective opposing upright panels to simultaneously provide structural support for the cabinet and to retain the electronics sub-assembly frame opposite portions of an outer edge thereof which are slidable therebetween.

2. The multi-purpose bracket according to claim 1, wherein the upper and lower legs are parallel to one another.

3. The multi-purpose bracket according to claim 2, wherein the lower leg and the connecting leg are substantially perpendicular to one another, and the connecting leg and the upper leg are substantially perpendicular to one another.

4. The multi-purpose bracket according to claim 1, wherein the lower leg is adapted for mounting to the bottom panel and the connecting leg is adapted for connection to one of the opposing upright panels by using mounting hardware.

5. The multi-purpose bracket according to claim 4, wherein the lower leg includes at least one hole adapted for mounting to the bottom panel using the mounting hardware, and wherein the connecting leg includes at least one hole adapted for mounting to at least one of the group consisting of the side panel and the transverse panel using the mounting hardware.

6. The multi-purpose bracket according to claim 5, wherein each of the at least one hole comprises a clearance hole adapted to receive mounting hardware comprising a screw.

7. The multi-purpose bracket according to claim 1, wherein the upper leg includes a plurality of retaining tab pairs separated by at least one recess.

8. The multi-purpose bracket according to claim 7, wherein an area of the connecting leg immediately adjacent each recess is extended vertically beyond the upper leg to comprise at least one mounting tab.

9. The multi-purpose bracket according to claim 8, wherein the lower leg includes at least one hole adapted for mounting to the bottom panel using the mounting hardware, and wherein each mounting tab includes at least one hole adapted for mounting to one of the opposing upright panels.

10. The multi-purpose bracket according to claim 7, wherein at least one retaining tab includes an access recess for a tool to tighten and loosen hardware disposed through a hole in the lower leg adjacent said access recess.

11. The multi-purpose bracket according to claim 1, wherein the bracket is elongate, being of a length roughly corresponding to the length of an edge of the mounting frame engaged thereby.

12. The multi-purpose bracket according to claim 11, wherein the upper leg includes a plurality of retaining tab pairs separated by at least one recess.

13. The multi-purpose bracket according to claim 12, wherein a pair of retaining tabs are disposed at respective opposite ends of the bracket.

14. The multi-purpose bracket according to claim 13, wherein the mounting hardware comprises a screw for insertion through the hole, the hole being adapted to receive said screw.

15. The multi-purpose bracket according to claim 14, further comprising a pair of mounting tabs and a center retaining tab disposed between said pair of mounting tabs.

16. The multi-purpose bracket according to claim 15, wherein the lower leg is adapted for mounting to the bottom panel and the connecting leg is adapted for connection to one of the opposing upright panels by using mounting hardware.

17. The multi-purpose bracket according to claim 16, wherein at least one retaining tab includes an access recess for a tool to tighten and loosen hardware disposed through a hole in the lower leg adjacent said access recess.

18. The multi-purpose bracket according to claim 13, wherein the bracket is made of sheet metal.

19. The multi-purpose bracket according to claim 18, wherein the sheet metal comprises steel that is coated to prevent corrosion.

20. The multi-purpose bracket according to claim 11, wherein the lower leg is adapted for mounting to the bottom panel and the connecting leg is adapted for connection to one of the opposing upright panels by using mounting hardware.

21. A method for retaining a mounting frame of an electronics chassis sub-assembly within an electronics cabinet, comprising the steps of:
providing a pair of multi-purpose brackets adapted for mounting to a bottom panel and to one of a pair of opposing upright panels of an electronics cabinet, the bracket also being adapted to connect to an electronics chassis sub-assembly mounting frame; and
mounting the pair of brackets in an opposing, spaced parallel relationship in the cabinet to the bottom panel and to the respective opposing upright panels to simultaneously provide structural support for the cabinet and provide the ability to retain the mounting frame in the cabinet.

22. The method according to claim 21, further comprising the step of engaging opposite portions of an outer edge of the frame with the mounting brackets to retain the mounting frame within the cabinet.

23. The method according to claim 21, further comprising the step of providing a third multi-purpose bracket adapted for mounting to the bottom panel and to an upright panel of the cabinet, the third multi-purpose bracket being perpendicularly disposed to the opposing upright panels, the third multipurpose bracket also being adapted to connect to the mounting frame.

24. The method according to claim 21, wherein the step of providing a pair of multi-purpose brackets comprises providing brackets of the type having a lower leg adapted for mounting to the bottom panel, a connecting leg angularly dependent from an edge of the lower leg, the connecting leg being adapted for o mounting to one of the opposing upright panels.

25. The method according to claim 24, further comprising the step of slidably engaging opposite portions of an outer edge of the frame with the mounting brackets to retain the mounting frame within the cabinet.

26. The method according to claim 24, further comprising the step of providing a third multi-purpose bracket adapted for mounting to the bottom panel and to an upright panel of the cabinet disposed perpendicular to the opposing upright panels, the third multi-purpose bracket also being adapted to connect to the mounting frame.
